(19) United States
(12) Patent Application Publication
(10) Pub. No.: US 2025/0207452 A1
(43) Pub. Date: Jun. 26, 2025

(54) FURNITURE DRIVE

(71) Applicant: Julius Blum GmbH, Hoechst (AT)

(72) Inventors: Bjoern GASSER, Mellau (AT); Alexander Peterlunger, Lustenau (AT); Klaus Mattle, Koblach (AT)

(21) Appl. No.: 19/073,924

(22) Filed: Mar. 7, 2025

Related U.S. Application Data
(63) Continuation of application No. PCT/AT2023/060297, filed on Aug. 30, 2023.

(30) Foreign Application Priority Data
Sep. 9, 2022 (AT) A 50689/2022

(51) Int. Cl. E05F 15/63

(52) U.S. Cl. CPC E05F 15/63; E05Y 2201/462; E05Y 2600/13; E05Y 2900/20

(57) ABSTRACT

A furniture drive having an actuating arm with a coupling device for coupling the actuating arm to at least one drive part and at least one output part rotatable relative thereto. A coupling intensity between the at least one drive part and the at least one output part is adjustable by an adjustment device, and the at least one drive part and the at least one output part are arranged at a distance from one another to form a gap. The gap is filled with a magnetorheological medium that can be influenced by a magnetic field, and the adjustment device for adjusting the coupling intensity has a device for generating a magnetic field for magnetic polarization of the magnetorheological medium.

The present application is a continuation of International Application PCT/AT2023/060297 filed on Aug. 30, 2023. Thus, all of the subject matter of International Application PCT/AT2023/060297 is incorporated herein by reference.

### BACKGROUND OF THE INVENTION

The invention relates to a furniture drive and to a piece of furniture with such a furniture drive. In the state of the art, furniture drives for an actuating arm with different coupling devices for the actuating arm are known.

EP 1 861 572 B1 shows a piece of furniture with a furniture drive and a movable actuating arm, wherein a coupling device is effective between an electric drive and the actuating arm, which has a freewheel in at least one direction of rotation over a limited angle of rotation range for freely moving the actuating arm into an open position and/or into a closed position. The disadvantage of this type of coupling device is that it is not possible to adjust a coupling intensity.

EP 1 903 909 B1 shows a coupling of a furniture drive that can be switched by means of a cable pull. A coupling intensity cannot be adjusted for such a type of coupling device either. In addition, such a coupling based on frictional forces can be subject to adverse wear and tear.

EP 1 981 371 B1 shows a furniture drive with a drive unit and a slip coupling, wherein the slip coupling is formed such that it decouples the drive unit and the ejector from each other when a predetermined torque is exceeded. The slip coupling works on the basis of the diameter of a wrap spring, which means that a coupling intensity for such a type of coupling device is disadvantageously difficult to adjust, for example by completely replacing the wrap spring.

EP 2 086 372 B1 shows a furniture drive with a coupling device for at least temporarily transmitting a force to an actuating arm, wherein the coupling device is formed in the shape of a sleeve freewheel. The disadvantage of this type of coupling device is that it is not possible to adjust a coupling intensity.

### SUMMARY OF THE INVENTION

The object of the invention is to provide a furniture drive and a piece of furniture which avoid the above-mentioned problems. This object is achieved by a furniture drive with the features described below, as well as a piece of furniture with such a furniture drive.

The furniture drive is suitable for driving an actuating arm. The furniture drive can be connected to an actuating arm or have an actuating arm. At least one movable furniture part of the piece of furniture can be connectable or connected to an actuating arm of the furniture drive. The piece of furniture can have a furniture body, wherein the furniture part can be arranged in an opening of the furniture body, or wherein the furniture part can close an opening of the furniture body. A movement of an actuating arm can take place accordingly between a retracted and an extended position of the furniture part or between an open position and a closed position of the furniture part.

The furniture drive has a coupling device with at least one drive part and at least one output part rotatable relative thereto. A drive of the furniture drive can act on the drive part. The output part can be connected or connectable to an actuating arm. The furniture drive can have several coupling devices. A coupling device can also have several drive parts and several output parts, for example in a series connection.

A coupling intensity between the at least one drive part and the at least one output part can be adjusted by an adjustment device. A coupling intensity can be adjustable between a substantially rigid coupling and a substantially eliminated force-transmitting connection between the at least one drive part and the at least one output part.

For the embodiment of the coupling device, the at least one drive part and the at least one output part are arranged spaced apart from one another to form a gap. The at least one drive part and the at least one output part can, for example, be arranged next to one another along a common axis at a predetermined or predeterminable distance and form a gap due to the spaced arrangement. The gap is filled with a magnetorheological medium that can be influenced by a magnetic field.

The adjustment device is formed for adjustment of the coupling intensity, wherein it has a device for generating a magnetic field for magnetic polarization of the magnetorheological medium.

A magnetorheological medium can consist of magnetizable solid particles in a carrier fluid. When an external magnetic field is applied, the solid particles can be magnetized and form chains along the field lines of the magnetic field. This allows a magnetorheological medium to undergo a controlled transition from a fluid-like to a substantially solid state. This means that a coupling intensity can be adjusted without wear simply by adjusting the device for generating a magnetic field.

The furniture drive can advantageously be coupled to and uncoupled from an actuating arm with the coupling device with a coupling intensity corresponding to the polarization of the magnetorheological medium. The coupling device can be used, for example, as an overload coupling, as a freewheel coupling, for coupling a damping device or for coupling a drive.

The device for generating a magnetic field for polarizing the magnetorheological medium can comprise at least one electromagnet with an energizable coil. By adjusting a current flowing through the coil, a coupling intensity can be adjusted depending on the polarization of the magnetorheological medium. Preferably, the energizable coil is arranged stationary in the furniture drive. The at least one drive part and at least one output part can each be arranged in the furniture drive so as to be rotatable relative to the coil.

It should not be excluded that the device for generating a magnetic field for polarizing the magnetorheological medium has several electromagnets and/or at least one permanent magnet.

In an arrangement of the drive part and the output part on an axis running through a coil of a device for generating a magnetic field, a magnetic field and thus a polarization of the magnetorheological medium can occur along the axis.

The drive part can be made of a magnetizable material and can protrude at least partially into an inner area of the coil. A magnetic flux generated by the energized coil can be guided by the drive part into a region of the gap. Preferably, a drive shaft projecting axially from the drive part can protrude into an inner area of the coil for coupling to a drive of the furniture drive.

The drive part can have a bearing shaft that projects axially centrally from the drive part to guide the output part. The output part can be rotatably mounted on the drive part, for example via a ball bearing arranged on the bearing shaft which projects axially centrally from the drive part. Preferably, the bearing shaft for conducting a magnetic flux should be made of a magnetizable material

The drive part and the output part can be arranged adjacent to one another along a common axis of rotation, wherein the gap can be formed at least axially. The drive part can be formed to be disk-shaped at least in sections. A disk-shaped section of the drive part can be arranged facing the gap. In other words, a disk-shaped section of the drive part can form an interface of the gap.

The drive part can have an axial projection at least in sections to form an open U-profile cross-section. In particular, the drive part can be formed to be disk-shaped at least in sections and can have an axial projection protruding therefrom at least in sections, for example a circumferentially axially projecting web. Preferably, the axial projection or web can be arranged in a radially located edge area of the drive part. The axial projection or web can form an interface of the gap.

The output part can be formed to be disk-shaped at least in sections. A disk-shaped section of the output part can be arranged facing the gap. In other words, a disk-shaped section of the output part can form an interface of the gap.

In an advantageous embodiment, the drive part can have an axial projection at least in sections to form an open U-profile cross-section and the output part can be arranged at least partially in the U-profile cross-section of the drive part. The gap can substantially be limited by the drive part and the output part. The drive part can at least partially enclose the output part radially, and the gap an be formed at least radially by the arrangement of the drive part to the output part.

Advantageously, a seal is arranged radially between the drive part and the output part to enclose the magnetorheological medium. In an arrangement of the drive part and the output part on an axis running through a coil of a device for generating a magnetic field, a magnetic field and thus a polarization of the magnetorheological medium can occur axially. Through a radial arrangement of a seal, the effective area of the gap can be maximized.

The drive part and/or the output part can have, at least in sections, a structured surface facing the gap to form a positive connection to the magnetorheological medium. The structured surfaces can in particular have an axial offset from one another. The structured surfaces can be embodied in the form of radial webs and radial recesses in the drive part and/or the output part. Due to the structured surfaces, shear forces can act on the magnetorheological medium when the output part rotates relative to the drive part.

The furniture drive can have an electric motor for driving an actuating arm, wherein an actuating arm can be coupled to and uncoupled from the electric motor with the coupling device corresponding to a coupling intensity.

The drive part can have a drive shaft that projects axially centrally from the drive part for connection to a drive of the furniture drive. The output part can be rotatably mounted in the drive part, for example via a ball bearing arranged on the bearing shaft which projects axially centrally from the drive part.

If the furniture drive has an electric motor for driving the actuating arm and the actuating arm can be coupled to and uncoupled from the electric motor with the coupling device corresponding to a coupling intensity, the electric motor can be operated as a generator to dampen the movement when an actuating arm connected to the output part moves. Damping of the movement of an actuating arm can be desired in particular in an end area of a limited movement of the actuating arm.

The furniture drive advantageously has a control for the adjustment device. If the adjustment device for adjusting the coupling intensity has a device for generating a magnetic field with at least one electromagnet with an energizable coil, the control can control and/or regulate a current intensity of the current flowing through the coil. Control and/or regulation can, for example, be carried out depending on an adjustment angle of an actuating arm connected to the output part. For example, an angle sensor can be used to detect an angle of rotation of the output part relative to a housing of the furniture drive and feed it to the controller. An electric motor of the furniture drive can also be controlled by the controller.

The furniture drive can have a mechanical force accumulator which can be connected or is connected to an actuating arm connected to the output part. The coupling device can be used to exert a force from the force accumulator and/or a force elicited by the electric motor on the actuating arm. For example, the mechanical force accumulator can be used to compensate for a weight force of a furniture part connected to the actuating arm, and the electric motor can be used to drive or dampen a movement of the furniture part.

Protection is also required for a piece of furniture with at least one furniture drive as described above. At least one movable furniture part of the piece of furniture can be connected or is connected to an actuating arm of the furniture drive connected to the output part.

The piece of furniture can have a furniture body with at least one wall, wherein the furniture drive is arrangeable or can be arranged in an installation position substantially completely in a recess in a wall of the furniture body.

### BRIEF DESCRIPTION OF THE DRAWINGS

Exemplary embodiments of the invention are discussed below with reference to the figures, in which:

FIGS. 1a and 1b are a perspective view and a sectional representation, respectively, of a first embodiment of a furniture drive,

FIG. 2 is an exploded representation of an embodiment of a coupling device,

FIGS. 3a and 3b are a perspective view and a sectional representation, respectively, of an embodiment of a coupling device,

FIGS. 4a and 4b are sectional representations of a coupling device and of parts of a coupling device,

FIGS. 5a and 5b are sectional representations of parts of a coupling device,

FIG. 6 is a sectional representation of a second embodiment of a furniture drive,

FIGS. 7a and 7b are perspective views of a piece of furniture, and

FIG. 8 is a schematic representation of a furniture drive with a controller.

### DETAILED DESCRIPTION OF THE INVENTION

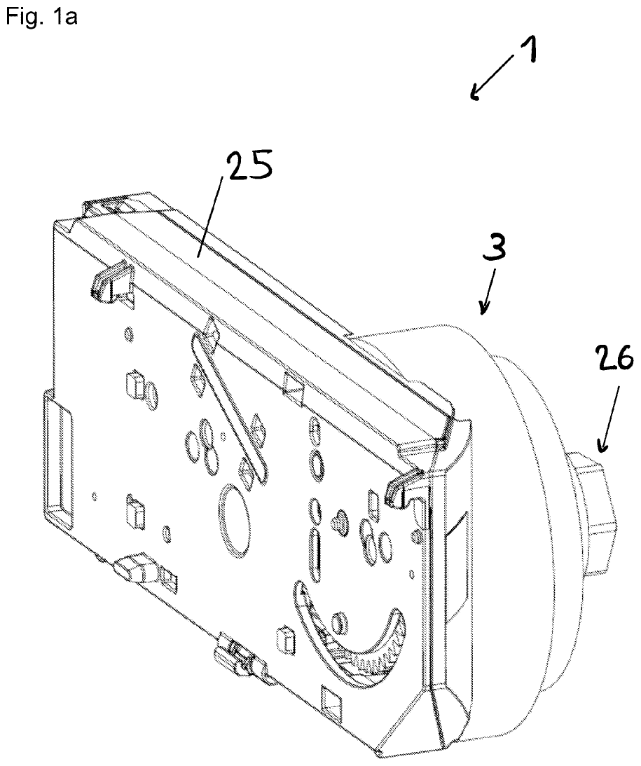

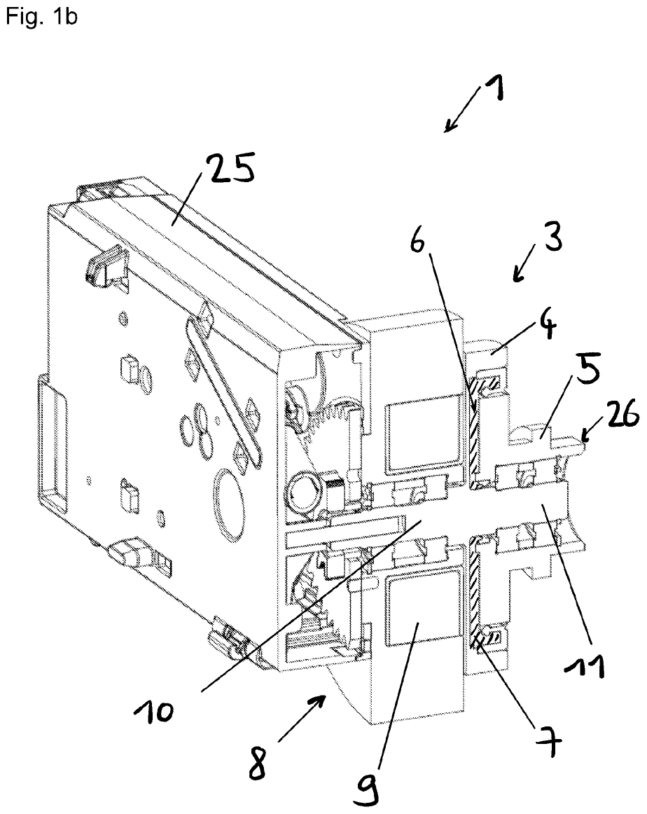

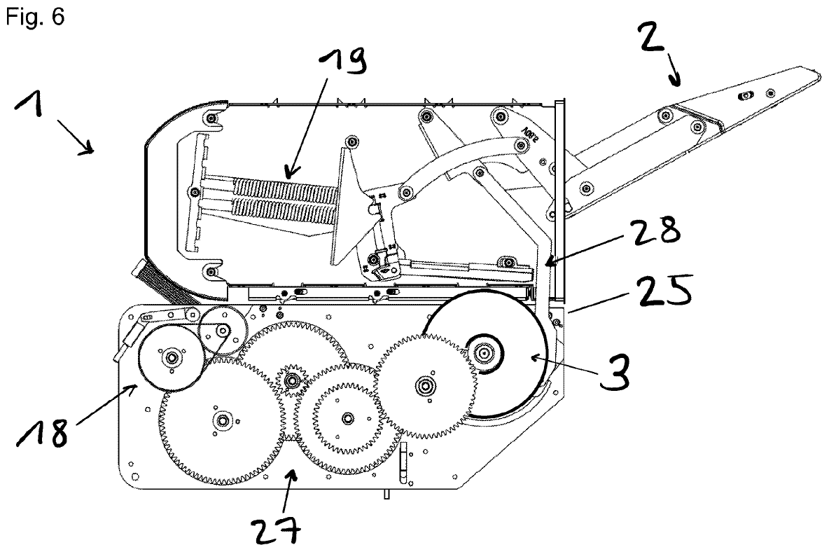

FIG. 1a shows a perspective view of a furniture drive 1 in a first embodiment. FIG. 6 shows a sectional representation of a second embodiment of a furniture drive 1 in side view, wherein in this view an actuating arm 2 connected to the furniture drive is represented. It goes without saying that an actuating arm 2 can also be provided for the first embodiment of the furniture drive 1 shown in FIG. 1a.

FIG. 1a shows a furniture drive 1 for an actuating arm 2 with a housing 25 and a coupling device 3 with a receiving area 26 for an actuating arm 2. As can be seen in the sectional representation of FIG. 1b, the furniture drive 1 has at least one drive part 4 and at least one output part 5 which can be rotated relative thereto. The at least one drive part 4 and the at least one output part 5 are arranged spaced from one another to form an axial and radial gap 6. The gap 6 is filled with a magnetorheological medium 7 represented in hatched form.

With an adjustment device which has a device for generating a magnetic field 8, a coupling intensity between the at least one drive part 4 and the at least one output part 5 can be adjusted, wherein a coupling intensity can be adjusted via the magnetic polarization of the magnetorheological medium 7.

With the coupling device 3, an actuating arm 2 can be coupled to, and uncoupled from, the furniture drive 1 with a coupling intensity corresponding to the polarization of the magnetorheological medium 7.

In the embodiment shown, the device for generating a magnetic field 8 for polarizing the magnetorheological medium 7 has at least one electromagnet with an energizable coil 9. As represented, the energizable coil 9 is arranged stationary in the furniture drive 1.

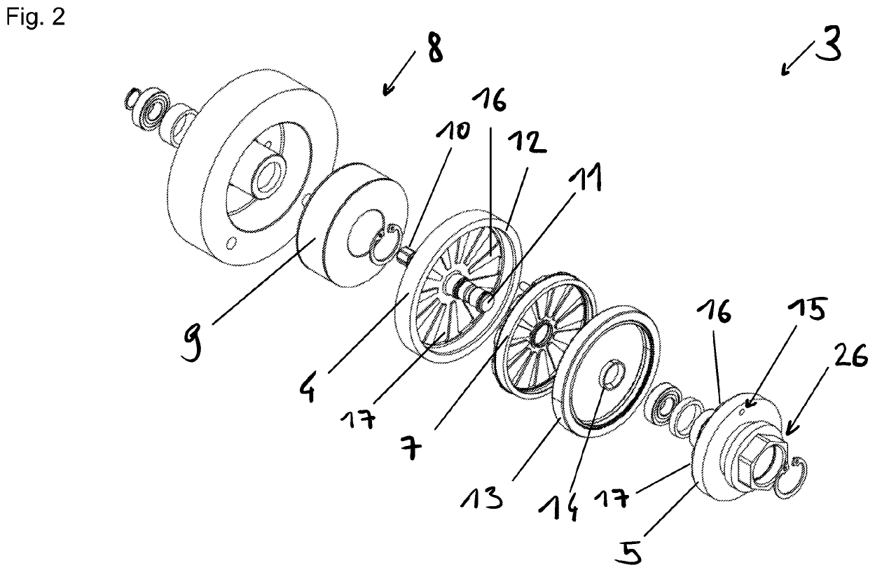

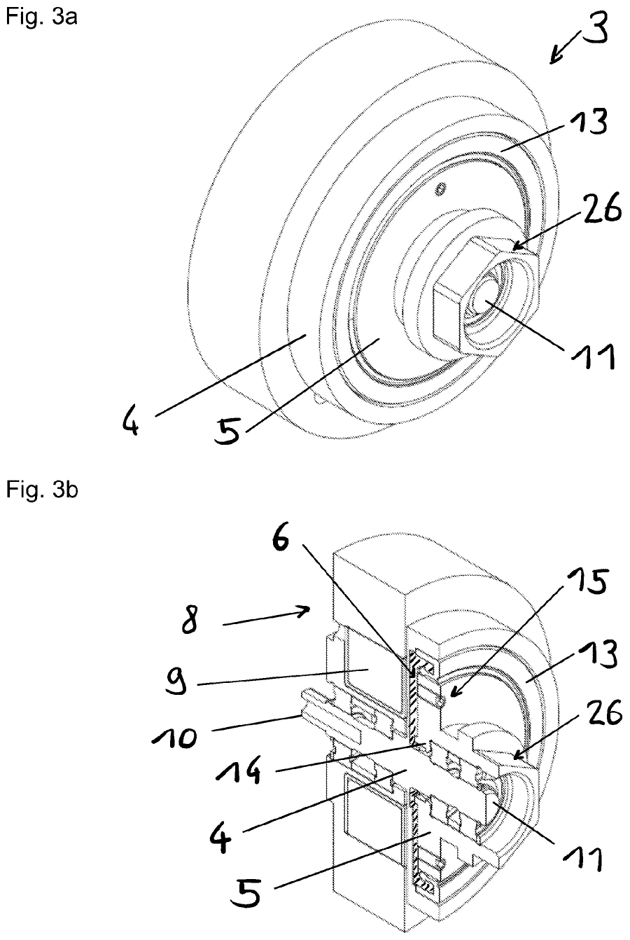

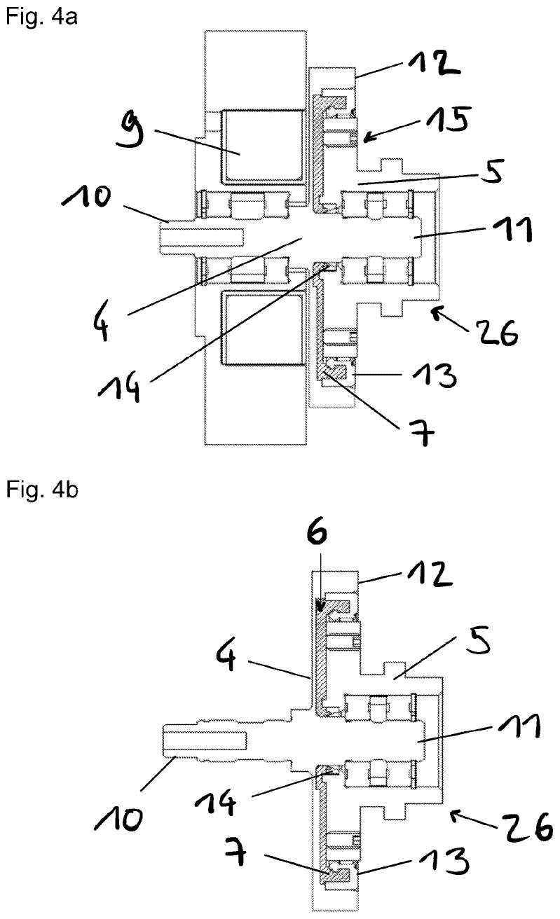

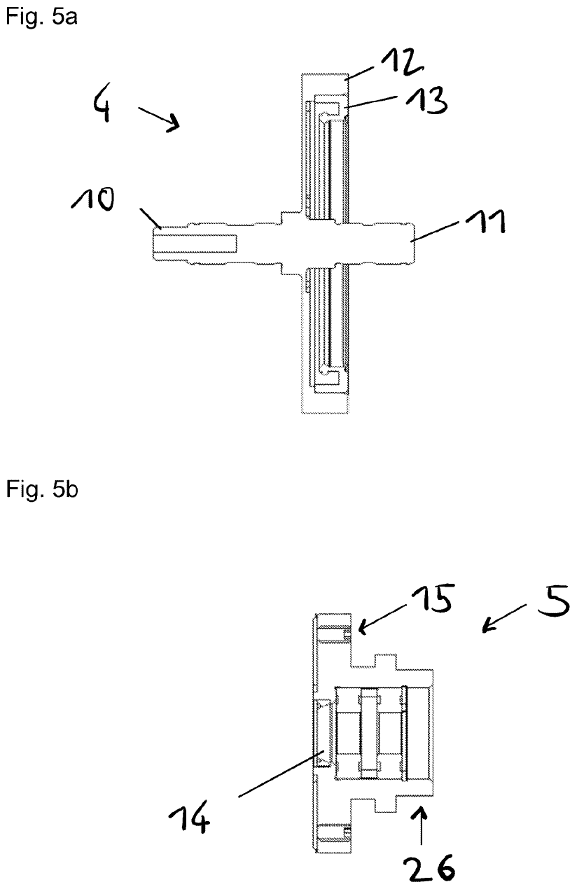

FIG. 2 shows an exploded representation of an embodiment of a coupling device 3. FIGS. 3a and 3b show a perspective view and a sectional representation of a coupling device 3. FIGS. 4a and 4b and 5a and 5b show sectional representations of a coupling device and of parts of a coupling device. In the figures it can be seen that the drive part 4 has a drive shaft 10 which projects axially from the drive part 4 for coupling to a drive of the furniture drive 1, which, as represented, protrudes into an inner area of the coil 9. The drive part 4 can be rotatably mounted via the axially projecting drive shaft 10 in the housing 25 of the furniture drive 1, for example via ball bearings. In the embodiment shown, the drive part 4 is formed to be disk-shaped at least in sections and has a circumferential axial projection 12 in an edge area to form an open U-profile cross-section (see in particular FIGS. 2 and 4b). The drive part 4 further has a bearing shaft 12 which projects axially centrally from the drive part 4 to guide the output part 5. The output part 5 can be rotatably mounted thereon, for example via ball bearings.

In the embodiment shown, the output part 5 is formed to be disk-shaped at least in sections.

As can be seen in particular in FIGS. 1b and 4b, the drive part 4 and the output part 5 can be arranged adjacent to one another along a common axis of rotation and the gap 6 can be formed at least axially. The gap 6 can also be formed at least radially.

Due to the open U-profile cross-section of the drive part, the output part 5 can be arranged at least partially in the U-profile cross-section of the drive part 4. The drive part 4 can at least partially enclose the output part 5 radially.

Radial seals 13, 14 can be arranged between the drive part 4 and the output part 5, whereby the volume formed between the drive part 4 and the output part 5 for the magnetorheological medium 7 can be sealed. The volume of the magnetorheological medium 7 is illustrated, for example, in the exploded representation of FIG. 2. To fill the volume formed between the drive part 4 and the output part 5 for the magnetorheological medium 7, ventilation openings 15 can be provided in the output part.

In FIG. 2 it can be seen that the drive part 4 and the output part 5 can have, at least in sections, a structured surface with webs 16 and recesses 17 facing the gap 6 to form a positive connection to the magnetorheological medium 7.

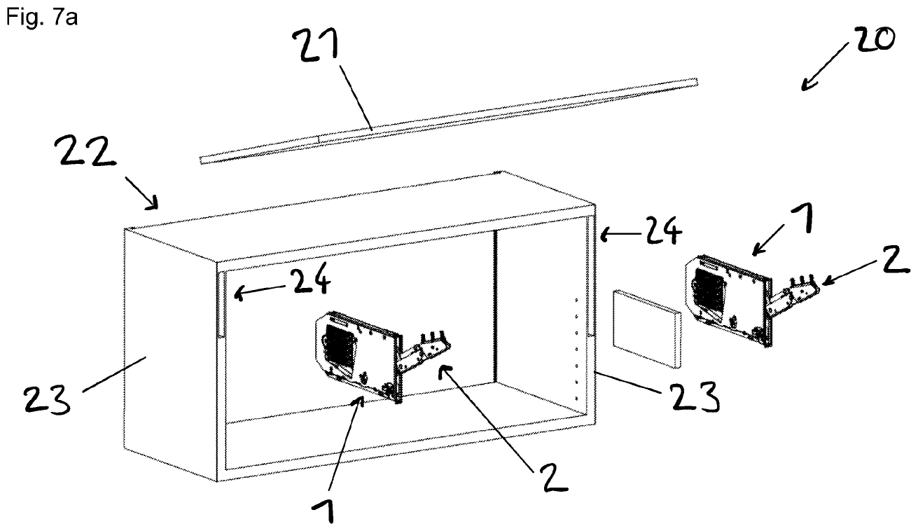

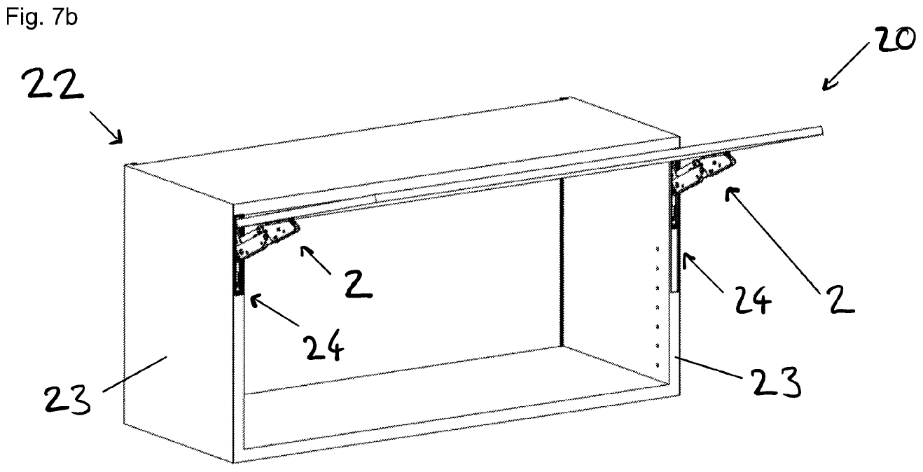

FIG. 6 shows a second embodiment of a furniture drive 1. The furniture drive can have a coupling device 3 as described above. In this embodiment, the coupling device 3 is connected to a rod 28 with an actuating arm 2 for a movable furniture part 21 (see FIGS. 7a and 7b). The rod 28 can, for example, be connected via a gear and a rack to the connecting region 26 hidden in the figure. With the coupling device 3, the actuating arm 2 can be coupled to and uncoupled from the furniture drive 1 with a coupling intensity corresponding to the polarization of the magnetorheological medium 7.

In the second embodiment shown, the furniture drive 1 has an electric motor 18 for driving an actuating arm 2 connected to the output part 5. With the coupling device 3, the actuating arm 2 can be coupled to and uncoupled from the electric motor 18 corresponding to a coupling intensity. Further, the furniture drive 1 in the second embodiment has a mechanical force accumulator 19 which is connected to the actuating arm 2 via levers. With the coupling device 3, a force from the force accumulator 19 and/or a force elicited by the electric motor 18 can be exerted on the actuating arm 2 connected to the output part 5 corresponding to a coupling intensity. The electric motor 18 can also be operated as a generator to dampen the movement during a movement of the actuating arm 2—in particular in an end area of a limited movement of the actuating arm 2.

FIGS. 7a and 7b show an embodiment of a piece of furniture 20 with two furniture drives 1 as described above. A movable furniture part 21 in the shape of a furniture flap of the piece of furniture 20 is connected to the actuating arms 2 of the furniture drives 1. As represented, the piece of furniture 20 has a furniture body 22 with at least one wall 23, wherein a furniture drive 1 in each case in an installation position shown in FIG. 7b can be arranged substantially completely in a recess 24 in a wall 23 of the furniture body 22.

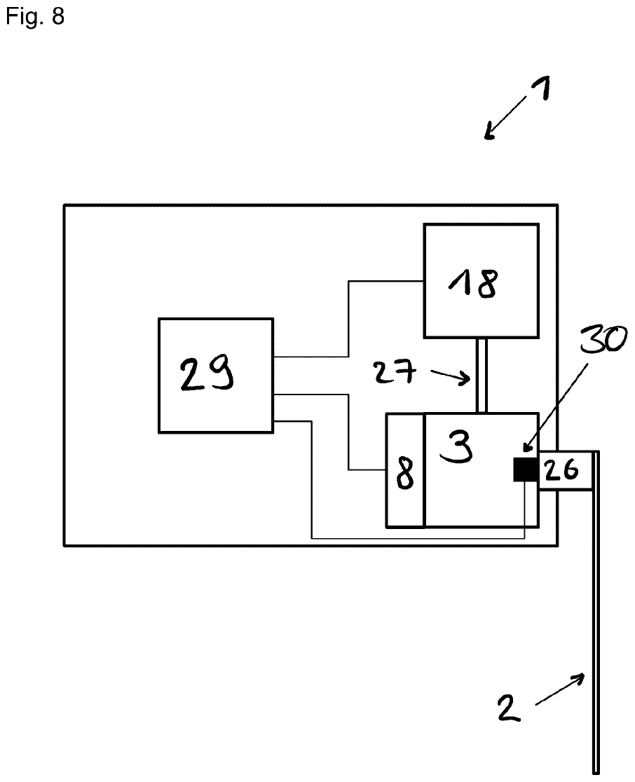

FIG. 8 schematically shows a furniture drive 1 with a controller 29 for the device for generating a magnetic field 8 of the adjustment device. If the adjustment device for adjusting the coupling intensity has a device for generating a magnetic field 8 with at least one electromagnet with an energizable coil 9 as described before (see, e.g., FIG. 1b), the controller 29 can control and/or regulate a current intensity of the current flowing through the coil 9. Control and/or regulation can, for example, be carried out depending on an adjustment angle of an actuating arm 2 connected to the output part. For this purpose, for example, an angle of rotation of the output part 5 relative to a housing 25 (see, e.g., FIG. 1a or FIG. 6) of the furniture drive 1 can be detected with an angle sensor 30 and fed to the controller 29. An electric motor 18 of the furniture drive can also be controlled by the controller 29. The controller 29 can be integrated into the furniture drive 1 or formed separately from it.

### LIST OF REFERENCE NUMERALS

1 furniture drive
2 actuating arm
3 coupling device
4 drive part
5 output part
6 gap
7 magnetorheological medium
8 device for generating a magnetic field
9 coil
10 drive shaft
11 bearing shaft
12 projection
13 seal
14 seal
15 vent opening
16 web
17 recess
18 electric motor
19 mechanical force accumulator
20 piece of furniture
21 furniture part
22 furniture body
23 wall
24 recess
25 housing
26 connection area
27 transmission
28 rod
29 controller
30 sensor

1. A furniture drive comprising:
an actuating arm with a coupling device for the actuating arm with at least one drive part and at least one output part to be rotated relative thereto,
wherein a coupling intensity between the at least one drive part and the at least one output part can be adjusted with an adjustment device,
wherein the at least one drive part and the at least one output part are arranged spaced apart from one another to form a gap,
wherein the gap is filled with a magnetorheological medium that can be influenced by a magnetic field, and the adjustment device for adjusting the coupling intensity has a device for generating a magnetic field for magnetic polarization of the magnetorheological medium.

2. The furniture drive according to claim 1, wherein the actuating arm connected to the output part can be coupled to and uncoupled from the furniture drive with a coupling intensity corresponding to the polarization of the magnetorheological medium with the coupling device.

3. The furniture drive according to claim 1, wherein the device for generating a magnetic field for polarizing the magnetorheological medium has at least one electromagnet with an energizable coil, wherein the energizable coil is preferably arranged stationary in the furniture drive.

4. The furniture drive according to claim 1, wherein the drive part is made of a magnetizable material and at least partially protrudes into an inner area of the coil, wherein preferably a drive shaft projecting axially from the drive part protrudes into an inner area of the coil.

5. The furniture drive according to claim 1, wherein the drive part for guiding the output part has a bearing shaft projecting axially centrally from the drive part, wherein preferably the bearing shaft is made of a magnetizable material.

6. The furniture drive according to claim 1, wherein the drive part and the output part are arranged adjacent to one another along a common axis of rotation and the gap is formed at least axially.

7. The furniture drive according to claim 1, wherein the drive part is formed to be disk-shaped at least in sections.

8. The furniture drive according to claim 1, wherein the drive part has an axial projection at least in sections, preferably in an edge region, to form an open U-profile cross-section.

9. The furniture drive according to claim 1, wherein the output part is formed to be disk-shaped at least in sections.

10. The furniture drive according to claim 1, wherein the drive part has an axial projection at least in sections to form an open U-profile cross-section and the output part is arranged at least partially in the U-profile cross-section of the drive part.

11. The furniture drive according to claim 10, wherein the drive part at least partially radially encloses the output part.

12. The furniture drive according to claim 1, wherein the gap is formed at least radially.

13. The furniture drive according to claim 12, wherein at least one radial seal is arranged between the drive part and the output part.

14. The furniture drive according to claim 1, wherein the drive part and/or the output part have a structured surface facing the gap at least in sections to form a positive connection to the magnetorheological medium.

15. The furniture drive according to claim 1, wherein the furniture drive has an electric motor for driving the actuating arm connected to the output part, and with the coupling device, the actuating arm can be coupled to and uncoupled from the electric motor according to a coupling intensity.

16. The furniture drive according to claim 15, wherein the furniture drive has a mechanical force accumulator which can be connected or is connected to the actuating arm connected to the output part, wherein with the coupling device, a force from the force accumulator and/or a force elicited by the electric motor can be exerted on the actuating arm connected to the output part corresponding to a coupling intensity.

17. The furniture drive according to claim 1, wherein the drive part has a drive shaft projecting axially centrally from the drive part for connection to a drive of the furniture drive.

18. The furniture drive according to claim 1, wherein the furniture drive has an electric motor for driving the actuating arm and with the coupling device, the actuating arm can be coupled to and uncoupled from the electric motor corresponding to a coupling intensity, wherein the electric motor can be operated as a generator for dampening the movement when the actuating arm moves—in particular in an end area of a limited movement of the actuating arm.

19. A use of the furniture drive according to claim 1 in a piece of furniture.

20. A piece of furniture with at least one furniture drive according to claim 1, wherein at least one movable furniture part of the piece of furniture can be connected or is connected to the actuating arm of the furniture drive.

21. The piece of furniture according to claim 20, wherein the piece of furniture has a furniture body with at least one wall, wherein the furniture drive in an installed position can be arranged or is arranged substantially completely in a recess in a wall of the furniture body.
